(19) United States
(12) Patent Application Publication
(10) Pub. No.: US 2015/0120863 A1
(43) Pub. Date: Apr. 30, 2015

(54) PROXY NETWORK DEVICE SELECTION IN A COMMUNICATION NETWORK

(71) Applicant: QUALCOMM INCORPORATED, SAN DIEGO, CA (US)

(72) Inventors: Xin Wu, Shanghai (CN); Zhilong Yang, Shanghai (CN); Hangtian Zhu, Shanghai (CN)

(73) Assignee: QUALCOMM INCORPORATED, SAN DIEGO, CA (US)

(21) Appl. No.: 14/063,971

(22) Filed: Oct. 25, 2013

(51) Int. Cl. H04L 29/08

(52) U.S. Cl. CPC H04L 67/28
USPC 709/217

(57) ABSTRACT

A first network device determines that a central coordinator of a communication network cannot be detected and designates itself as a hidden network device. The first network device receives a beacon message from a second network device including a first communication parameter that indicates that the second network device has proxy capabilities and a second communication parameter. The first network device selects the second network device as its proxy network device, if the second communication parameter of the second network device is a preferred communication parameter as compared to a corresponding second parameter of an additional network device detected at the first network device. If the first network device is a proxy network device for a third network device, then messages received from the third network device for forwarding to the central coordinator are relayed from the first network device to the second network device.

### BACKGROUND

Embodiments of the inventive subject matter generally relate to the field of communication networks and, more particularly, to proxy network device selection in a communication network.

Electric transmission and distribution lines are typically used for providing electric power from generators to buildings, residences, and other components of a city's infrastructure. The electric power may be transmitted over the transmission lines at a high voltage, and may be distributed to buildings and other structures at much lower voltages using electric power lines. Besides providing electric power, electric power lines can also be used to implement powerline communications in both indoor and outdoor environments. Powerline communications can provide another communication medium for connecting various network nodes together in local and wide area networks.

### SUMMARY

Various embodiments for proxy network device selection in a communication network are disclosed. In one embodiment, a first network device determines that a central coordinator of a communication network cannot be detected by the first network device. The first network device receives a beacon message from a second network device, the beacon message including a first communication parameter that indicates that the second network device has proxy capabilities and a second communication parameter. The first network device determines that the second communication parameter of the second network device is a preferred communication parameter as compared to a corresponding second communication parameter of at least one additional network device. The first network device selects the second network device as a proxy network device for communication between the first network device and the central coordinator.

### BRIEF DESCRIPTION OF THE DRAWINGS

The present embodiments may be better understood, and numerous objects, features, and advantages made apparent to those skilled in the art by referencing the accompanying drawings.

FIG. 1 is an example block diagram of a communication network including a proxy network device selection mechanism;

FIG. 2 is a flow diagram illustrating example operations of a hidden network device selecting a proxy network device;

FIG. 3 is a flow diagram illustrating example operations for determining whether to execute proxy selection operations;

FIG. 4 is a flow diagram illustrating example operations of a hidden network device selecting a proxy network device;

FIG. 5 is a flow diagram illustrating example operations for selecting a proxy network device at the hidden network device;

FIG. 6 is a conceptual diagram illustrating example operations for constructing the routing table in a multi-level relay environment; and

FIG. 7 is a block diagram of one embodiment of an electronic device including a mechanism for selection of a proxy network device.

### DESCRIPTION OF EMBODIMENT(S)

The description that follows includes exemplary systems, methods, techniques, instruction sequences, and computer program products that embody techniques of the present inventive subject matter. However, it is understood that the described embodiments may be practiced without these specific details. For instance, although examples refer to proxy network device selection in a powerline communication (PLC) network (e.g., a HomePlug® AV network), embodiments are not so limited. In other embodiments, operations for proxy network device selection described herein can be executed by network devices that implement other suitable communication protocols and techniques (e.g., wireless local area network (WLAN) protocols, such as IEEE 802.11b/g/n, multimedia over coax alliance (MoCA), etc.). In other instances, well-known instruction instances, protocols, structures, and techniques have not been shown in detail in order not to obfuscate the description.

Powerline communication (PLC) technology is typically used in an indoor environment, for example, to interconnect network devices in a home network. When PLC technology is implemented in an outdoor environment, such as a smart power grid, conditions inherent to the outdoor environment may cause performance degradation in the communication network. For example, communication between two network devices in the outdoor environment may not be reliable (or may not be possible) due to longer distances, network congestion, or poor signal quality. To overcome such limitations, a network device may attempt communication via an intermediate “proxy” network device. Conventional proxy selection techniques typically rely on a central coordinator of the communication network to select a proxy network device to facilitate communications for a network device (“hidden network device”) that is unable to detect the central coordinator. Before assigning the proxy network device to the hidden network device, conventional proxy selection techniques usually require the central coordinator to have knowledge of the entire topology of the communication network and routing information for each network device in the communication network. Transmission of large amounts of routing information may be inefficient and error-prone, especially in a poor performing outdoor environment.

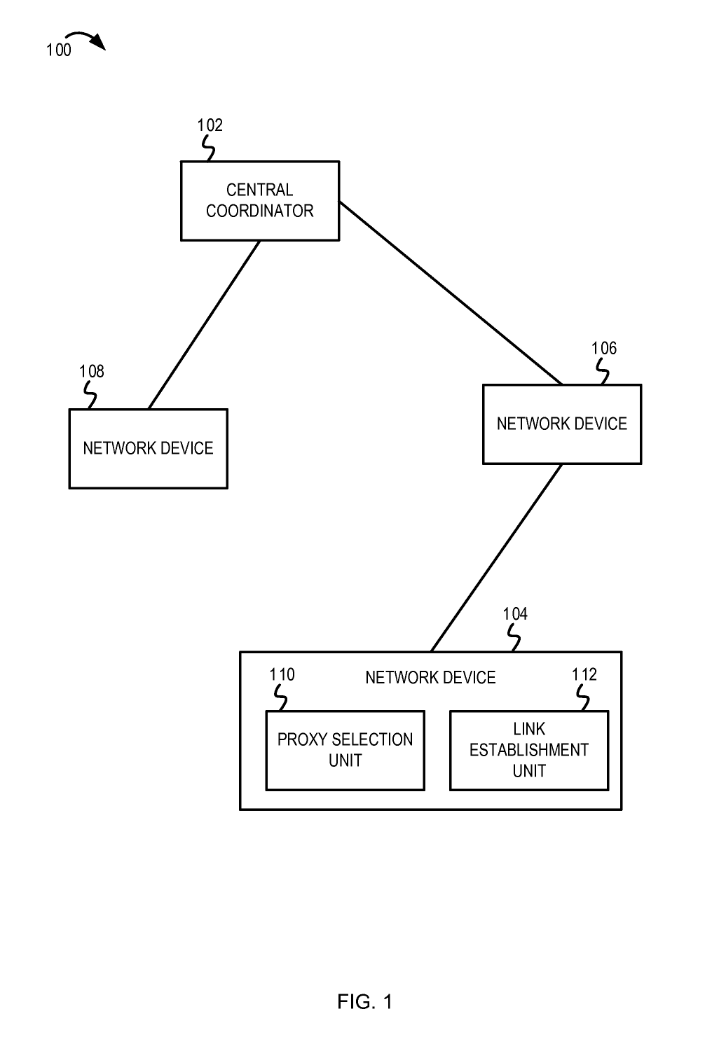

In some embodiments, instead of the central coordinator selecting the proxy network device, the hidden network device can be configured to select an appropriate proxy network device that can facilitate communication between the hidden network device and the central coordinator. The hidden network device can use various factors to select the proxy network device from proxy-capable network devices detected by the hidden network device. The hidden network device can select the proxy network device based on one or more factors, such as whether an existing proxy network device was detected, the number of other hidden network devices currently being served by each detected existing proxy network device, the number of communication links between the central coordinator and each of the detected network devices, a performance measurement associated with each of the detected network devices, as will be described below with reference to FIGS. 1-5. The hidden network device can associate with the central coordinator via the proxy network device and then communicate with the central coordinator via the proxy network device. The hidden network device can select the proxy network device without intervention from the central coordinator, which can improve the speed and reliability of selecting the proxy network device.

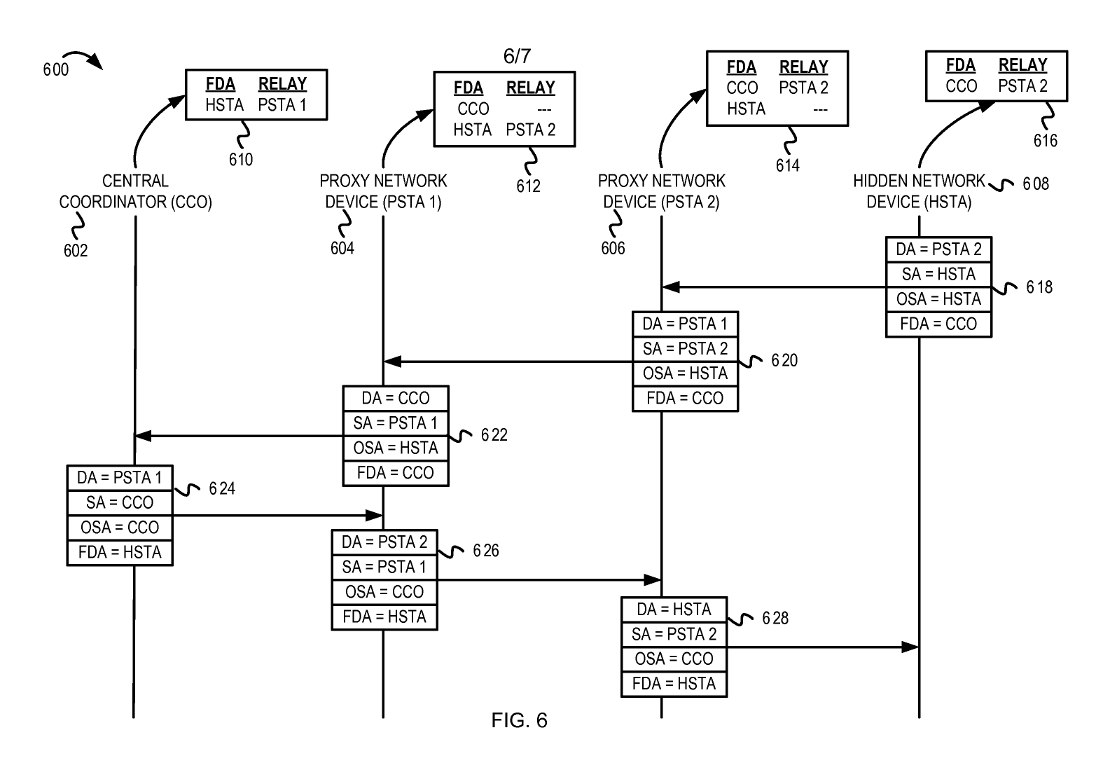

Additionally, in some embodiments, a multi-level forwarding mechanism can be employed in the communication network. Each network device that cannot directly connect to the central coordinator can select an upper-level proxy network device via which to communicate with the central coordinator, as will be described with reference to FIG. 6. For example, a first network device may select a second network device as its upper-level proxy network device; the second network device may select a third network device as its upper-level proxy network device; and so on until an upper-level proxy network device is selected that is directly connected to the central coordinator. A multi-level selection of proxy network devices may help support a variety of different communication network topologies, ensure that each network device in the communication network is directly or indirectly connected with the central coordinator, and improve connectivity in the outdoor environment.

FIG. 1 is an example block diagram of a communication network 100 including a proxy network device selection mechanism. The communication network 100 includes a central coordinator 102 and network devices 104, 106, and 108. The network device 104 includes a proxy selection unit 110 and a link establishment unit 112. Although not depicted in FIG. 1, the network devices 106 and 108 may also each include a proxy selection unit and/or a link establishment unit.

In some implementations, the central coordinator 102 and the network devices 104, 106, and 108 can each be an electronic device in an outdoor powerline communication environment. For example, the outdoor PLC environment can be a smart power grid. In this example, the central coordinator 102 and the network devices 104, 106, and 108 can be PLC devices or electronic devices with PLC capabilities configured to operate in the outdoor environment. In some implementations, the central coordinator 102 and the network devices 104, 106, and 108 can be electronic devices and other network nodes such as power meters, electric vehicle charging stations, power generators, electric power distribution devices, laptop computers, tablet computers, mobile phones, smart appliances, gaming consoles, access points, or other suitable electronic devices with various communication capabilities (e.g., WLAN communication capabilities, PLC capabilities, Ethernet communication capabilities, etc.). In some embodiments, in addition to WLAN communication protocols (e.g., IEEE 802.11 communication protocols), the central coordinator 102 and the network devices 104, 106, and 108 may implement other protocols and functionality to enable other types of communications (e.g., Bluetooth®, WiMAX, Ethernet, PLC, etc.). For example, the central coordinator 102 and the network devices 104, 106, and 108 may each include one or more radio transceivers, processors, memory, and logic to implement the communication protocols and related functionality

In one example, the communication network 100 can be a HomePlug AV Logical Network (AVLN). Within the communication network 100, the central coordinator 102 and network devices 104, 106, and 108 can support any suitable network topology, such as a mesh topology, tree topology, star topology, bus topology, etc. In some embodiments, the central coordinator 102 and network devices 104, 106, and 108 can be configured to communicate using HomePlug AV communication protocols, GreenPHY communication protocols, or other suitable powerline communication protocols. In addition, the central coordinator 102 and network devices 104, 106, and 108 may be configured to implement other suitable wired or wireless communication protocols (e.g., WLAN, Ethernet, MoCA, etc.).

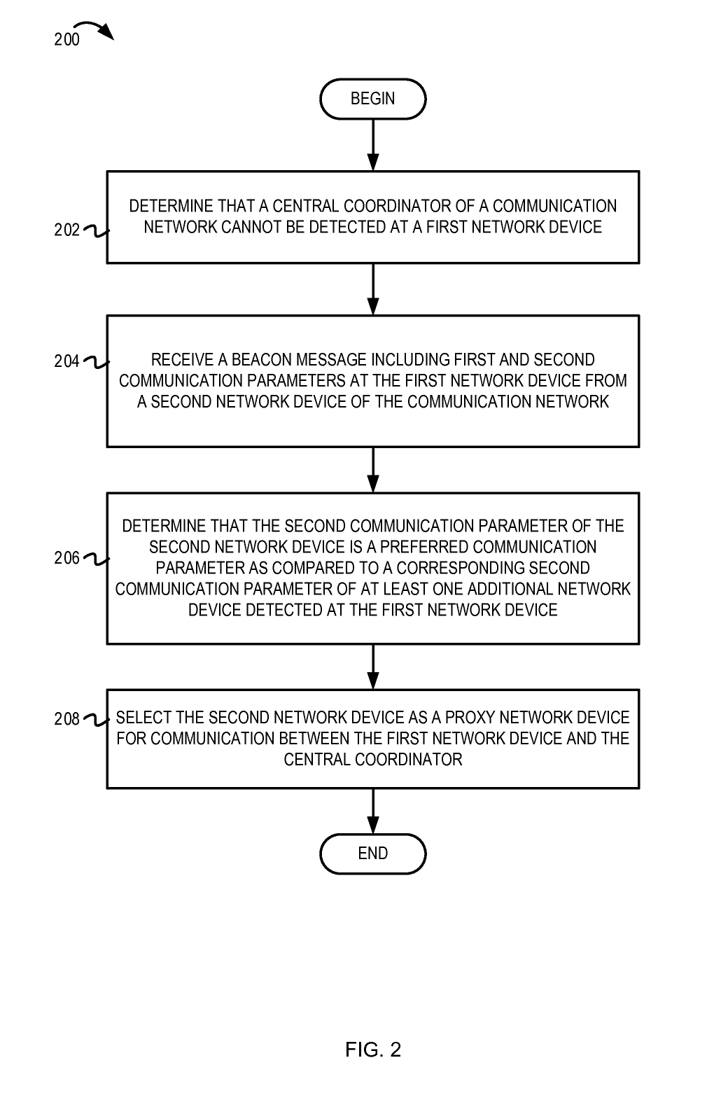

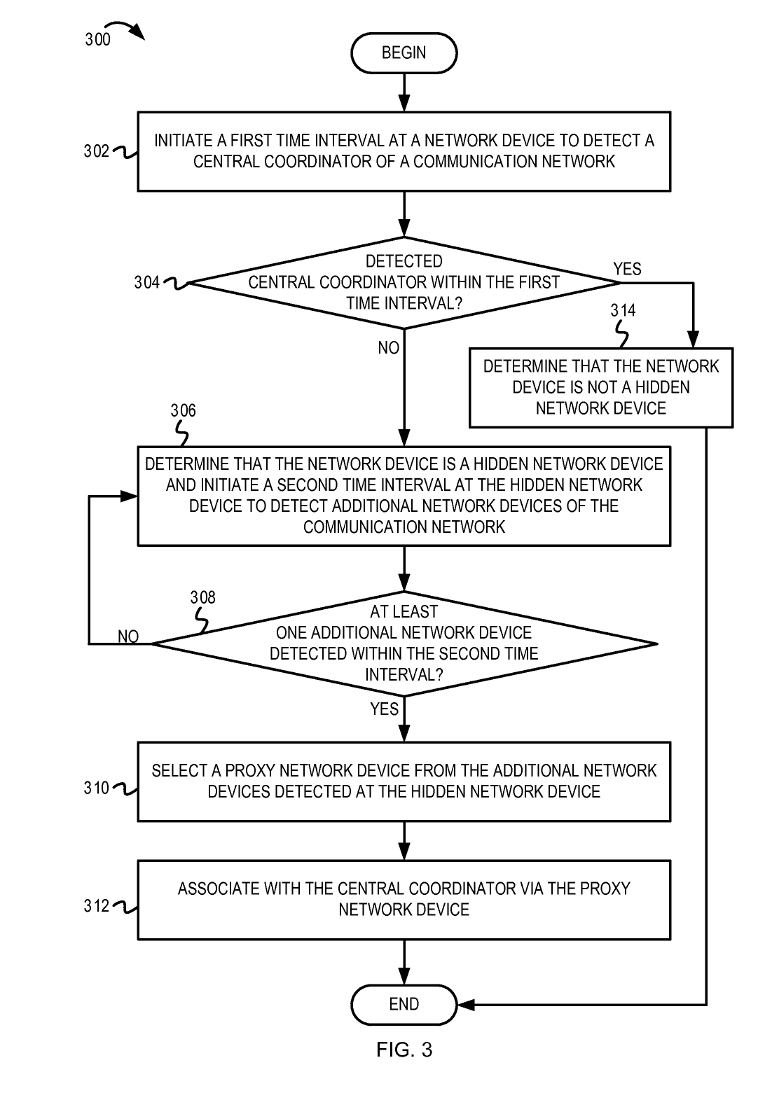

In some embodiments, the central coordinator 102 can be a network device that controls communications within the communication network 100. The network devices 104, 106, and 108 can associate with the central coordinator 102 to join the communication network 100. However, in some embodiments, communication between two network devices in the communication network 100 may not be reliable or possible due to longer distances, network congestion, or poor signal quality. For example, the link establishment unit 112 of the network device 104 may not be able to detect the central coordinator 102 or may not receive a beacon message from the central coordinator 102 (“central beacon message”). The network device 104 that is unable to detect and directly communicate with the central coordinator 102 is herein referred to as a “hidden network device.” If the link establishment unit 112 is unable to detect the central coordinator 102, the link establishment unit 112 can infer that the network device 104 is a hidden network device, as will be further described with reference to FIG. 3. To overcome such limitations, the hidden network device 104 may attempt to communicate with the central coordinator 102 via an intermediate “proxy” network device. The proxy selection unit 110 of the hidden network device 104 can then attempt to identify a suitable proxy network device, as will be further described in FIGS. 2-5.

Each network device that successfully associates with the central coordinator 102 and joins the communication network 100 can be configured to broadcast a “discover” beacon message. By transmitting the discover beacon message, a network device (e.g., the network device 106) can indicates its presence in the communication network 100 and can enable hidden network devices (e.g., the network device 104) to detect the presence of the communication network 100. The central coordinator 102 can notify each associated network device to transmit a corresponding discover beacon message. In some embodiments, the central coordinator 102 may initiate a discover time interval during which the network devices may transmit their respective discover beacon message. In one example, the discover time interval may be initiated during the beacon interval. In another example, the discover time interval may be equal to, or the same as, the beacon interval. Typically, each network device may transmit one discover beacon message per beacon interval. In some embodiments, the central coordinator 102 can dynamically vary the discover time interval based, at least in part, on a number of associated network devices in the communication network 100. For example, as the number of associated network devices increases, the time interval between discover beacon messages transmitted by two network devices may decrease. In some embodiments, the central coordinator 102 may notify the associated network devices to transmit their respective discover beacon message after a predetermined number of network devices have successfully joined the communication network 100. In some embodiments, the central coordinator 102 may indicate (e.g., in the central beacon message) when each associated network device should transmit a corresponding discover beacon message. For example, the central coordinator 102 may indicate that the network device 104 should transmit a corresponding discover beacon message a predetermined time interval/offset after the beacon interval is initiated. As another example, the central coordinator 102 may indicate that the network device 104 should transmit a corresponding discover beacon message at a predetermined time interval/offset after the central coordinator 102 transmits the central beacon message.

In response to receiving the central beacon message from the central coordinator 102, each associated network device can transmit a corresponding discover beacon message at an appropriate time instant. In some embodiments, the discover beacon message may include information received from the central coordinator 102 in the central beacon message (e.g., communication capabilities of the central coordinator 102, an identifier of the communication network 100, etc.). In addition, the discover beacon message may also include at least one of an identifier of the network device transmitting the discover beacon message, communication capabilities of the network device, whether the network device has forwarding/relaying capabilities (e.g., whether the network device can become a proxy network device, if needed), whether the network device is currently configured as a proxy network device, a hop count associated with the network device (e.g., a number of communication hops or communication links between the network device and the central coordinator 102), etc. In some embodiments, the discover beacon message may also include a start time instant of the beacon interval, a duration of the beacon interval, and a time offset (from the start time instant) at which the discover beacon message was transmitted.

When a network device (e.g., the network device 106) is designated as the proxy network device, the proxy network device can periodically transmit a proxy beacon message indicating the presence of the proxy network device in the communication network 100. In some embodiments, the proxy network device may be directly connected to the central coordinator 102 (e.g., the proxy network device may be connected to the central coordinator 102 via one communication hop or one communication link). In this embodiment, the proxy network device can transmit the proxy beacon message in response to receiving the central beacon message from the central coordinator 102. In other embodiments, the proxy network device may not be directly connected to the central coordinator 102. Instead, the proxy network device may also be a hidden network device and may be unable to detect the central coordinator 102. In this embodiment, the proxy network device may also have an upper-level proxy network device to communicate with the central coordinator 102. In this embodiment, the lower-level proxy network device can transmit its proxy beacon message in response to receiving a proxy beacon message from its upper-level proxy network device.

More generally, a network device 106 may receive a central beacon message if it is directly connected to the central coordinator 102 or may receive an upper-level proxy beacon message from the upper-level proxy network device (that services the network device 106). In response to receiving the central beacon message or the upper-level proxy beacon message, the network device 106 may determine whether it is a proxy network device for a hidden network device. If so, the network device 106 can transmit its own proxy beacon message to enable synchronization of its hidden network devices. The network device 106 may transmit a proxy beacon message after receiving the central beacon message or after receiving the upper-level proxy beacon message. In some embodiments, the central beacon message or the upper-level proxy beacon message may indicate when the network device 106 should transmit the proxy beacon message during each beacon interval. As one example, the central beacon message or the upper-level proxy beacon message can indicate a time instant at which the network device 106 should transmit the proxy beacon message. As another example, the central beacon message or the upper-level proxy beacon message can indicate that the network device 106 should transmit the proxy beacon message a specified time offset after receiving the central/proxy beacon message. As another example, the network device 106 may transmit its proxy beacon message as soon as the network device 106 receives the central beacon message or the upper-level proxy beacon message. The proxy beacon message transmitted by the network device 106 may also include information originally transmitted by the central coordinator 102, an identifier of the network device 106, a start of the beacon interval, a hop count associated with the network device 106, and other suitable information. The hidden network devices connected to the network device 106 can synchronize with the network device 106 based, at least in part, on the received proxy beacon message. For example, the hidden network devices can update their respective local timers based, at least in part, on timing synchronization information in the received proxy beacon message.

Each directly-connected network device, proxy network device, and hidden network device in the communication network 100 may also maintain a discovered devices list. Each network device can update the corresponding discovered devices list based, at least in part, on information in discover beacon messages or proxy beacon messages received from other network devices in the communication network 100. For example, the network device 106 may receive a discover beacon message transmitted by the network device 108. The network device 106 may create (or update) an entry in the discovered devices list to include at least one of: A) an identifier (e.g., a terminal equipment identifier (TEI), a medium access control (MAC) address, etc.) of the network device 108, B) whether the network device 108 is the central coordinator, C) whether the network device 108 is currently configured as a proxy network device, D) whether the network device 108 has the functionality to operate as a proxy network device (if needed), E) the hop count associated with the network device 108, F) a performance measurement of a communication link between the network device 108 and the central coordinator 102, G) a performance measurement of a communication link between the network device 108 and the network device 106, H) a communication network to which the network device 108 belongs, and/or other suitable parameters. In some embodiments, each entry (and consequently each network device) in the discovered devices list may be associated with an aging timer. The aging timer associated with a network device may be reset every time a message is received from the network device. For example, the network device 106 may restart the aging timer associated with the network device 108 each time the network device 106 receives a message (e.g., a discover beacon message, a proxy beacon message, a broadcast message, a data message, etc.) transmitted/forwarded by the network device 108. The network device 106 may remove the entry that corresponds to the network device 108 from the discovered devices list after the corresponding aging timer elapses.

The central coordinator 102 can periodically query all the network devices (associated with the central coordinator 102) to receive their respective discovered devices list. The central coordinator 102 can use the discovered devices list received from each network device that has joined the communication network 100 to determine the network topology of the communication network 100. In some embodiments, the central coordinator 102 can request the network device 106 to transmit the corresponding discovered devices list, in response to receiving the discover beacon message (or proxy beacon message) from the network device 106. In another embodiment, the central coordinator 102 can request the discovered devices list from each network device at any suitable time instant/time offset during each beacon interval. In another embodiment, instead of sending the request during each beacon interval, the central coordinator 102 can request the discovered devices list from each network device at any suitable time instant every N beacon intervals (e.g., every two beacon intervals), where N is an integer greater than 2 and may be predefined or configurable.

In some embodiments, the proxy beacon message, the discover beacon message, and the central beacon message can each include a configurable field for indicating a “relay level” of the network device transmitting the beacon message. The relay level field can indicate whether the network device is a user-configured “static” proxy network device or a “dynamic” proxy network device selected by a hidden network device. The relay level field can also indicate a number of hidden network devices currently being serviced by the proxy network device and a hop count of the network device. In one embodiment, a predetermined number of bits of the relay level field may be assigned to indicate the number of hidden network devices currently being serviced by the proxy network device. In another embodiment, the predetermined number of bits can indicate a range of the quantity of hidden network devices serviced by the proxy network device. For example, if two bits are assigned to indicate the number of hidden network devices, the value 00 can indicate that the proxy network device services 1-9 hidden network devices; the value 01 can indicate that the proxy network device services 10-29 hidden network devices; the value 10 can indicate that the proxy network device services 30-59 hidden network devices; and the value 11 can indicate that the proxy network device services more than 60 hidden network devices. In some embodiments, a predetermined number of bits of the relay level field can be assigned to indicate the hop count of the network device. For example, if 4 bits are assigned to indicate the hop count, the value 0000 can indicate that the network device is the central coordinator, the value 0001 can indicate that the network device is directly connected to the central coordinator, and the values 0010-1111 can indicate a hop count of 2-15. It is noted that the relay level field can have any suitable number of bits and any suitable subset of bits of the relay level field can be assigned to describe the network device. In some embodiments, the beacon message can include a proxy capability field that is distinct from the relay level field. The proxy capability field can be used to indicate whether the network device transmitting the beacon message has proxy capabilities and/or whether the network device is currently operating as a proxy network device. In other embodiments, the relay level field may also be used to indicate whether the network device is currently operating as a proxy network device and/or whether the network device has proxy capabilities. As will be further described below, the hidden network device can use the information in the relay level field to select an appropriate proxy network device.

Although examples refer to using a predetermined number of bits to indicate a parameter of the relay level field, embodiments are not so limited. In other embodiments, the network devices 102, 104, 106, and 108 may use a configurable number of bits to indicate a parameter of the relay level field. The configurable number of bits may be statically configured (e.g., during an initialization/startup process) or dynamically configured.

FIG. 2 is a flow diagram (“flow”) 200 illustrating example operations of a hidden network device selecting a proxy network device. The flow 200 begins at block 202.

At block 202, a first network device determines that a central coordinator of a communication network cannot be detected in the communication network. As will be further described with reference to blocks 302-304, a link establishment unit 112 may initiate a time interval for receiving central beacon messages from the central coordinator 102. If the link establishment unit 112 does not receive a predetermined number of consecutive central beacon messages or does not receive central beacon messages during a predetermined/configurable time interval, the link establishment unit 112 can infer that the first network device 102 cannot detect the central coordinator 102. The link establishment unit 112 may infer that the first network device 104 is a hidden network device. The flow continues at block 204.

At block 204, a beacon message including first and second communication parameters is received at the first network device from a second network device of the communication network. The first communication parameter may be used to indicate that the second network device has proxy capabilities. The second communication parameter may be used to select an appropriate proxy network device at the first network device. The second communication parameter may be a parameter in a relay level field in the received beacon message. The second communication parameter may indicate at least one of whether the second network device is currently configured as a proxy network device, a proxy configuration of the second network device (e.g., whether the second network device is a static or dynamic proxy network device), a number of other hidden network devices currently being serviced by the second network device, a hop count associated with the second network device, a performance measurement of a communication link between the second network device and an upper-level proxy network device (or central coordinator 102), and/or other suitable parameters.

As described with reference to FIG. 1, the first network device 104 may receive a proxy beacon message or a discover beacon message from the second network device 106. A proxy-capable network device that is currently operating as a proxy network device (also referred to as an “existing proxy network device”) may transmit the proxy beacon message. The discover beacon message may be transmitted by any network device that has successfully joined the communication network 100, irrespective of whether the network device has proxy capabilities. The first communication parameter of the proxy beacon message and the discover beacon message may indicate whether the network device is a proxy-capable network device. For example, the network device may transmit a first predefined value for the first communication parameter to indicate that the network device is not a proxy-capable network device. The network device may transmit a second predefined value for the first communication parameter to indicate that the network device is a proxy-capable network device.

The second communication parameter of the proxy beacon message and the discover beacon message may indicate the hop count, the number of hidden network devices being serviced, the performance measurement, the proxy configuration, and/or other suitable relay level parameters of the network device. As will be further described below, the proxy selection unit 110 can select the proxy network device based, at least in part, on the first communication parameter and the second communication parameter received from the second network device. In some embodiments, after the first network device determines that it cannot detect the central coordinator at bock 202, the first network device can initiate a second time interval to attempt to detect additional proxy-capable network devices (e.g., the second network device). Operations for initiating the second time interval and detecting additional proxy-capable network devices will be further described with reference to blocks 306 and 308 of FIG. 3. The flow continues at block 206.

At block 206, the first network device determines that that the second communication parameter of the second network device is a preferred communication parameter as compared to a corresponding second communication parameter of at least one additional network device detected at the first network device. For example, after determining that the first network device 104 is unable to detect the central coordinator 102, the first network device 104 may receive a plurality of beacon messages from a plurality of network devices of the communication network. Each of the received beacon messages may include a corresponding first communication parameter that indicates whether the network device that transmitted the beacon message has proxy capabilities. Furthermore, each of the received beacon messages may include a corresponding second communication parameter. The second communication parameter of the second network device 106 may be compared against a corresponding second communication parameter of each of the additional network devices. For example, if the second communication parameter indicates a hop count, then the hop count of the second network device may be compared against the hop count of each of the additional network devices. As another example, if the second communication parameter is a combination parameter indicating the proxy configuration and the hop count, then the combination parameter of the second network device may be compared against the combination parameter of each of the additional network devices. The network device with the preferred second communication parameter (e.g., the preferred hop count) may be identified. The flow continues at block 208.

At block 208, the first network device selects the second network device as a proxy network device for communication between the first network device and the central coordinator. For example, the proxy selection unit 110 can designate the second network device as the proxy network device, in response to determining that the second communication parameter of the second network device is a preferred communication parameter as compared to corresponding second communication parameter of each of the additional network devices. From block 208, the flow ends.

FIG. 3 is a flow diagram 300 illustrating example operations for determining whether to execute proxy selection operations. The flow 300 begins at block 302.

At block 302, a network device initiates a first time interval to detect a central coordinator of a communication network. With reference to the example of FIG. 1, the link establishment unit 112 of the network device 104 can initiate first time interval to detect the central coordinator 102. The network device 104 may detect the central coordinator 102 after receiving a central beacon message transmitted by the central coordinator 102. In some embodiments, the first time interval for detecting the central coordinator 102 may be equal to the beacon interval of the central coordinator 102. In another embodiment, the first time interval for detecting the central coordinator 102 may be a predetermined multiple of the beacon interval. In other embodiments, the first time interval may be any suitable preconfigured or dynamically configured time interval. During the first time interval, the network device 104 may attempt to detect the central beacon message. The network device 104 may discard/ignore any discover beacon messages received from other network devices or proxy beacon messages received from network devices that are currently operating as proxy network devices. The flow continues at block 304.

At block 304, it is determined whether the network device detected the central coordinator 102 is within the first time interval. In some embodiments, the link establishment unit 112 may designate the network device 104 as a hidden network device after failing to receive a predetermined number of consecutive central beacon messages from the central coordinator 102. As another example, the link establishment unit 112 may designate the network device 104 as a hidden network device after failing to receive a central beacon message for a predetermined number of consecutive beacon intervals or for another configurable time interval. If the link establishment unit 112 detects the central coordinator 102 within the first time interval, the proxy selection unit 110 may determine that the network device 104 is not a hidden network device at block 314. If the link establishment unit 112 does not detect the central coordinator 102 during the first time interval, the proxy selection unit 110 may determine that the network device 104 is a hidden network device and the flow continues at block 306.

At block 306, the hidden network device initiates a second time interval to detect additional network devices of the communication network for selecting a proxy network device. With reference to example of FIG. 2, after determining that the central coordinator cannot be detected, the first network device may initiate the second time interval to detect the second network device and the additional network devices. As discussed above, each network device associated with the central coordinator 102 can be configured to broadcast a discover beacon message in each beacon interval to indicate its presence in the communication network 100. Additionally, each network device designated/configured as a proxy network device may also broadcast a proxy beacon message in each beacon interval to indicate the presence of proxy network device in the communication network 100. As described above, transmission of the discover beacon messages and/or the proxy beacon messages can enable the hidden network device to detect (and possibly join) the communication network 100. The proxy selection unit 110 can initiate the second time interval during which the network device 104 waits to detect other network devices by receiving discover beacon messages and/or proxy beacon messages. In some embodiments, the second time interval may be equal to the beacon interval of the central coordinator 102. In another embodiment, the second time interval may be a multiple of the beacon interval. In other embodiments, the second time interval may be any suitable preconfigured or dynamically configured time interval. The proxy selection unit 110 can record information received in the discover beacon messages and/or proxy beacon messages. For example, for each received discover beacon message and/or proxy beacon message, the proxy selection unit 110 can record: 1) an identifier (e.g., a TEI, a MAC address, etc.) of a network device that transmitted the beacon message, 2) a hop count of the transmitting network device, 3) whether the transmitting network device is currently configured as a proxy network device, 4) whether the transmitting network device is a statically configured or dynamically configured proxy network device, 5) a number of hidden network devices currently being serviced by the transmitting network device, 6) a performance measurement between the transmitting network device and the central coordinator 102, 7) a performance measurement between the transmitting network device and the hidden network device, and/or other suitable information. After the second time interval elapses, the proxy selection unit 110 can use the recorded information to select an appropriate proxy network device to enable communications between the hidden network device and the central coordinator 102, as will be further described below. The flow continues at block 308.

At block 308, it is determined whether at least one additional network device was detected within the second time interval. If the hidden network device detects at least one additional network device before the second time interval elapses, the flow continues at block 310. Otherwise, if the hidden network device does not detect any network devices during the second time interval, the flow loops back to block 306 where the hidden network device restarts the second time interval and waits to receive a central beacon message, a discover beacon message, and/or a proxy beacon message. In some embodiments, if the hidden network device does not detect any additional network devices during the second time interval (or for a multiple of the second time interval), the proxy selection unit 110 may infer that the hidden network device cannot join the communication network 100. The proxy selection unit 110 may provide a notification to a user indicating that the hidden network device cannot join the communication network 100.

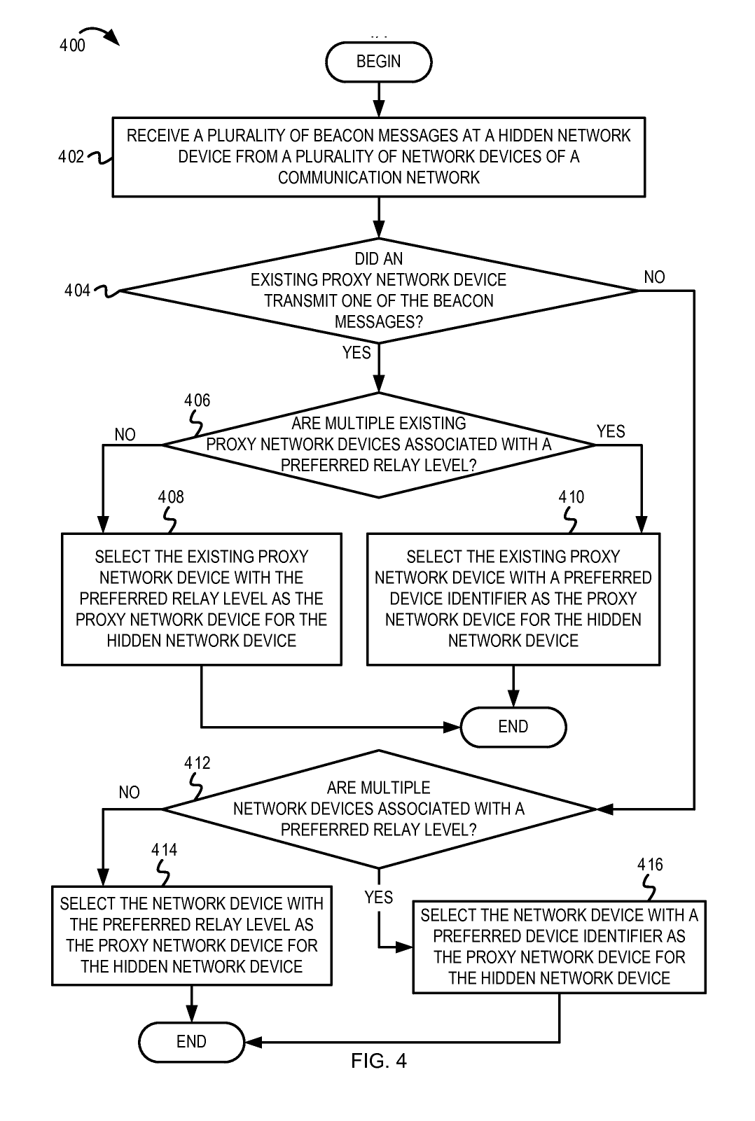

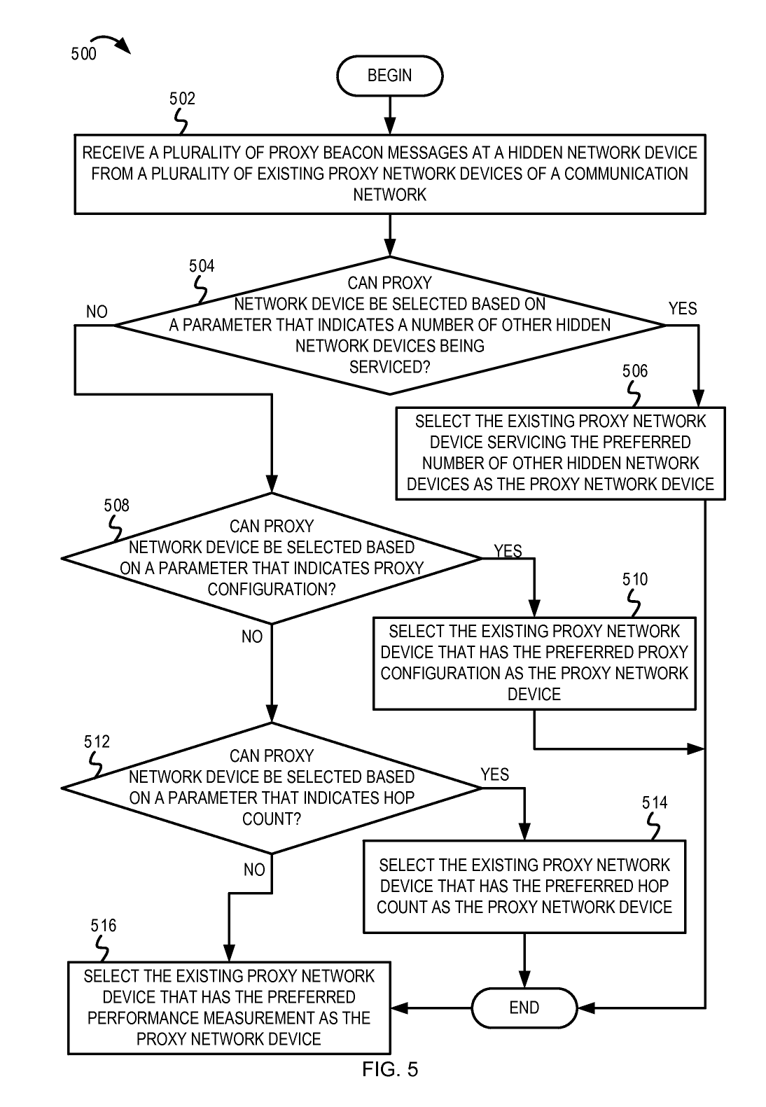

At block 310, the proxy network device is selected from the additional network devices detected at the hidden network device. In some embodiments, after detecting the additional network devices, the proxy selection unit 110 may inspect the additional network devices to identify the proxy-capable network devices. In some embodiments, the received proxy/discover beacon messages may each include a parameter (referred to as “first communication parameter” in FIG. 2) that indicates whether the network device is a proxy-capable network device. After identifying the proxy-capable network devices, the proxy selection unit 110 can use one or more other parameters (referred to as “second communication parameter” in FIG. 2) to select an appropriate proxy network device from the proxy-capable network devices. As will be further described with reference to FIGS. 4-5, the proxy selection unit 110 can use at least one of the hop count, current configuration, device identifier, performance measurement, and/or other suitable relay level parameters determined from the received proxy/discover beacon messages to select the proxy network device for the hidden network device. In some embodiments, the proxy selection unit 110 determines whether a network device that is currently operating as a proxy network device transmitted one of the detected discover/proxy beacon messages. A proxy-capable network device that is currently operating as a proxy network device is herein referred to as an “existing proxy network device.” If so, the proxy selection unit 110 can designate the existing proxy network device as the proxy network device for the hidden network device. In some embodiments, if the proxy selection unit 110 detects multiple existing proxy network devices, the proxy selection unit 110 can select the existing proxy network device that is servicing the fewest number of other hidden network devices. In some embodiments, if the proxy selection unit 110 detects multiple existing proxy network devices, the proxy selection unit 110 can select an appropriate proxy network device based, at least in part, on the proxy configuration of each detected proxy network device (e.g., whether each detected proxy network device is statically configured or dynamically configured). In some embodiments, the proxy selection unit 110 can select a network device associated with a preferred performance measurement as the proxy network device for the hidden network device. In some embodiments, in selecting the proxy network device, the proxy selection unit 110 can also take into consideration the number of communication hops (or communication links) between the network device and the central coordinator 102. More generally, the proxy selection unit 110 can compare communication parameters associated with each of the detected proxy-capable network devices. The proxy selection unit 110 can select the proxy-capable network device associated with a preferred communication parameter as the proxy network device for the hidden network device. The flow continues at block 312.

At block 312, the hidden network device associates with the central coordinator via the proxy network device. For example, the link establishment unit 112 of the hidden network device can transmit an association request to the proxy network device for forwarding to the central coordinator 102. The link establishment unit 112 can receive an association response from the central coordinator 102 via the proxy network device. If association is successful, the hidden network device can join the communication network 100 and exchange subsequent communications with the central coordinator 102 via the proxy network device. From block 312, the flow ends.

At block 314, after detecting the central coordinator, the network device determines that it is not a hidden network device and exchanges communications with the central coordinator. The network device 104 can synchronize its communications to a central beacon message transmitted by the central coordinator 102. For example, the network device 104 can update its local timers based, at least in part, on timing synchronization information in the received central beacon message. Any proxy beacon messages and/or discover beacon messages detected by the network device may not be used to synchronize the network device 104. As discussed above, the proxy beacon messages and/or discover beacon messages may be used to update a discovered devices list to determine the topology of the communication network 100. From block 314, the flow ends.

Although not depicted in FIG. 3, in some embodiments, if the network device 106 is directly connected to the central coordinator 102, the network device 106 may initiate a first time interval during each beacon interval for receiving the central beacon message from the central coordinator 102. If the network device 106 is unable to detect the central beacon message during the first time interval, the network device 106 may disassociate itself from the central coordinator 102 so that the network device 106 is no longer part of the communication network 100. The unassociated network device 106 may continue to attempt to detect the central coordinator 102 during a second time interval that is consecutive to the first time interval. If the network device 106 is unable to detect the central beacon message during the second time interval, the network device 106 may be designated as a hidden network device. The network device 106 may then execute operations described herein to select a proxy network device for the network device 106.

FIG. 4 is a flow diagram 400 illustrating example operations of a hidden network device selecting a proxy network device. The flow begins at block 402.

At block 402, the hidden network device receives a plurality of beacon messages from a plurality of network devices of a communication network. For example, the link establishment unit 112 of the hidden network device may receive proxy beacon messages and/or discover beacon messages from other network devices 106, 108 in the communication network 100. As discussed above with reference to FIG. 3, the hidden network device can begin to receive and process the discover/proxy beacon messages if the hidden network device does not detect the central coordinator 102 for a predetermined time interval. Additionally, as described above, each network device in the communication network (including associated hidden network devices and proxy network devices) may be configured to transmit a discover beacon message to indicate its presence in the communication network. Also, each proxy network device may be configured to transmit a proxy beacon message to indicate that it is currently operating as a proxy network device (“existing proxy network device”) in the communication network. After receiving the discover/proxy beacon messages the proxy selection unit 110 can select an appropriate proxy network device for the hidden network device, as will be further described below. In some example, the beacon messages may be received for a predetermined time interval and/or a configurable time interval. The flow continues at block 404.

At block 404, it is determined whether an existing proxy network device transmitted one of the beacon messages. For example, the proxy selection unit 110 can determine whether a proxy beacon message was received from an existing proxy network device of the communication network 100. Selecting an existing proxy network device as the proxy network device of the hidden network device can minimize the number of proxy network devices in the communication network 100, the number of proxy beacon messages transmitted, and transmission conflicts between beacon messages. If an existing proxy network device transmitted one of the beacon messages, the flow continues at block 406. Otherwise, the flow continues at block 412.

At block 406, it is determined whether multiple existing proxy network devices are associated with a preferred relay level. As described above with reference to FIG. 1, each proxy beacon message can indicate a relay level of the proxy network device that transmitted the proxy beacon message. The relay level can be a value in a relay level field within the proxy beacon message. For example, the relay level field can include at least one of a hop count associated with the proxy network device, a number of hidden network devices being serviced by the proxy network device, whether the proxy network device is statically or dynamically configured, etc. In some embodiments, the proxy selection unit 110 can select the existing proxy network device associated with a preferred relay level as the proxy network device of the hidden network device. In one example, the proxy network device with the preferred relay level may be determined based on comparing the relay level field in each received proxy beacon message. In another example, the relay level field in each received proxy beacon message may be compared against a threshold relay level. The threshold relay level may be a value representing a statically configured existing proxy network device that has a relatively low hop count (i.e., is connected to the central coordinator by a relatively small number of communication links), and services a relatively small number of other hidden network devices. The proxy network device may be deemed to have the preferred relay level if the value in the relay level field is equal to the threshold relay level. Alternatively, the proxy network device may be deemed to have the preferred relay level if the value in the relay level field is within a configurable/predetermined range of the threshold relay level.

In some embodiments, the relay level field may include multiple constituent parameters, such the hop count, performance measurement, number of serviced hidden network devices, communication capabilities, and so on. In one example of this embodiment, the proxy network device associated with the preferred value for each of the constituent parameters may have the preferred relay level. As another example, the proxy network device associated with the preferred value for a predetermined/configurable number of the constituent parameters may have the preferred relay level. In some embodiments, each of the constituent parameters may have a corresponding threshold value. For example, a proxy network device may have a preferred hop count if the hop count of the proxy network device is less than or equal to a hop count threshold. As another example, the proxy network device may have a preferred performance measurement if the performance measurement of the proxy network device is greater than or equal to a performance measurement threshold. As another example, the proxy network device may have a preferred hop count if the hop count of the proxy network device is within a predetermined and/or configurable range of the hop count threshold. In this embodiment, the proxy network device(s) associated with a highest number of preferred constituent parameters may have the preferred relay level.

In other embodiments, other suitable metrics (e.g., performance measurements between the existing proxy network device and the central coordinator 102 and/or performance measurements between the hidden network device and the existing proxy network device) can be used to select one of the existing proxy network devices. In some embodiments, the preferred relay level may be predetermined and/or configurable. If only one of the existing proxy network devices is associated with the preferred relay level, the flow continues at block 408. If multiple existing proxy network devices are associated with the preferred relay level or if none of the existing proxy network devices is associated with the preferred relay level, the flow continues at block 410.

At block 408, the existing proxy network device associated with the preferred relay level is selected as the proxy network device for the hidden network device. For example, if only one of the existing proxy network devices is associated with the preferred relay level, the proxy selection unit 110 can designate the existing proxy network device as the proxy network device for the hidden network device. From block 408, the flow ends.

At block 410, an existing proxy network device associated with a preferred device identifier is selected as the proxy network device for the hidden network device. If multiple or no existing proxy network devices are associated with the preferred relay level, the proxy selection unit 110 can use the device identifier or another suitable metric as a tiebreaker. The existing proxy network device associated with a preferred device identifier and the preferred relay level may be selected as the proxy network device for the hidden network device. In one example, the preferred device identifier may be the lowest MAC address or the lowest TEI. As another example, the preferred device identifier may be the highest MAC address or the highest TEI, etc. In some embodiments, the metric that is selected as the tiebreaker may be predetermined and/or configurable. From block 410, the flow ends.

At block 412, it is determined whether multiple network devices that are not currently operating as proxy network devices are associated with a preferred relay level. If the hidden network device does not detect any existing proxy network devices, the proxy selection unit 110 can analyze other network devices that are not currently operating as proxy network devices. The proxy selection unit 110 can analyze discover beacon messages received from additional network devices to determine whether any of the additional network devices have proxy capabilities. In some embodiments, the received discover beacon messages may include a parameter (referred to as “first communication parameter” in FIG. 2) that indicates whether the network device is a proxy-capable network device. After identifying the proxy-capable network devices, the proxy selection unit 110 can use one or more other parameters (referred to as “second communication parameter” in FIG. 2) to select the proxy network device from the proxy-capable network devices that are not currently operating as proxy network devices.

As described above, each discover beacon message can indicate a relay level of the network device that transmitted the discover beacon message. As discussed above, the relay level can be a value in a relay level field of the discover beacon message. For example, the relay level field can include a hop count associated with the network device. In some embodiments, the proxy selection unit 110 can select the network device 106 associated with a preferred relay level as the proxy network device of the hidden network device. Various techniques can be used to determine whether the network device 106 is associated with the preferred relay level, as described above with reference to block 406. For example, the network device with the preferred relay level may be determined based on comparing the relay level field in each received discover beacon message. As another example, the relay level field in each received discover beacon message may be compared against a threshold relay level. The threshold relay level may be a value representing a statically configured proxy-capable network device that has a relatively low hop count (i.e., is connected to the central coordinator by a relatively small number of communication links). The network device may be deemed to have the preferred relay level if the value in the relay level field is equal to (or within a configurable/predetermined range of) the threshold relay level. In other embodiments, other suitable metrics can be taken into consideration to select one of the network devices as the proxy network device. For example, performance measurements between the proxy-capable network device and the central coordinator 102 and/or performance measurements between the hidden network device and the proxy-capable network device may be used to select the proxy network device. If only one of the network devices is associated with the preferred relay level, the flow continues at block 414. If multiple network devices are associated with the preferred relay level, the flow continues at block 416.

At block 414, the network device associated with the preferred relay level is selected as the proxy network device for the hidden network device. For example, if only one the network devices is associated with the preferred relay level, the proxy selection unit 110 can designate that network device as the proxy network device for the hidden network device. From block 414, the flow ends.

At block 416, the network device associated with a preferred device identifier is selected as the proxy network device for the hidden network device. If multiple network devices are associated with the preferred relay level, the proxy selection unit 110 can use the device identifier or another suitable metric as a tiebreaker. In one example, the network device associated with the preferred relay level and the preferred device identifier (e.g., a highest TEI/MAC address) may be selected as the proxy network device for the hidden network device. In some embodiments, the metric that is selected as the tiebreaker may be predetermined and/or configurable. From block 416, the flow ends.

In some embodiments, identifying the network device associated with the preferred relay level may also include identifying the network device associated with a preferred performance measurement. The link establishment unit 112 can use received proxy/discover beacon messages to determine the performance measurement between the hidden network device and each of the network devices 106 and 108 detected at the hidden network device. For example, in response to receiving the proxy/discover beacon message from the network device 106, the link establishment unit 112 can determine the performance measurement of the communication link between the network device 106 and the network device 104. In some embodiments, the hidden network device may estimate the performance measurement associated with the network device 106 using a predetermined number of proxy/discover beacon messages or over a predetermined time interval. For example, the hidden network device may estimate the performance measurement associated with the network device 106 using proxy/discover beacon messages received from the network device 106 over a predetermined number of beacon intervals. As another example, the hidden network device may estimate the performance measurement associated with the network device 106 using a predetermined number of most recently received proxy/discover beacon messages from network device 106. In other embodiments, each network device 106 transmitting the proxy/discover beacon messages may include the performance measurement of a communication link between the network device 106 and an upper-level proxy network device (or the central coordinator 102) within the corresponding proxy/discover beacon message. For example, the network device 106 may determine the SNR of a communication link between the network device 106 and the central coordinator 102 based, at least in part, on a received central beacon message. As another example, the network device 106 may determine the SNR of a communication link between the network device 106 and an upper-level proxy network device based, at least in part, on a discover/proxy beacon message received from the upper-level proxy network device. As another example, the network device 106 may determine the SNR of a communication link between the network device 106 and the central coordinator 102 based, at least in part, on a predetermined number of consecutive received central beacon messages. The proxy selection unit 110 may use the performance measurement between each network device and a corresponding upper-level proxy network device (or the central coordinator), and/or the performance measurement between the hidden network device and each proxy-capable network device to select an appropriate proxy network device for the hidden network device.

FIG. 5 is a flow diagram 500 illustrating example operations for selecting a proxy network device at the hidden network device. Although the flow 500 depicts one example sequence for selecting a proxy network device; in other implementations, other sequences may be used to select the proxy network device. Furthermore, some of the operations described in the flow 500 may be performed concurrently. The flow 500 begins at block 502.

At block 502, a hidden network device receives a plurality of proxy beacon messages from a plurality of existing proxy network devices of a communication network. With reference to the example of FIG. 1, the link establishment unit 112 may receive beacon messages from the existing proxy network devices of the communication network 100. Each of the proxy beacon messages can include a parameter that indicates that the network device is a proxy-capable network device. Selecting an existing proxy network device as the proxy network device can minimize the number of proxy network devices in the communication network 100, the number of proxy beacon messages transmitted, and transmission conflicts between beacon messages. The flow continues at block 504.

At block 504, it is determined whether the proxy network device can be selected based on a parameter that indicates a number of other hidden network devices being serviced. If the link establishment unit 112 detects multiple existing proxy network devices, the proxy selection unit 110 can determine the number of hidden network devices controlled by each of the existing proxy network devices. The proxy selection unit 110 may determine how many other hidden network devices are serviced by an existing proxy network device based, at least in part, on an indicator included in the proxy beacon message received from the proxy network device. In one example, the proxy selection unit 110 may determine which of the existing proxy network devices service the fewest hidden network devices. In another example, the proxy selection unit 110 may compare the number of serviced hidden network devices against a threshold number. The existing proxy network device that services less than the threshold number of other hidden network devices may be deemed to have a preferred value of the parameter. If only one existing proxy network device services the preferred number of other hidden network devices, it may be determined that the proxy network device can be selected based on the number of other hidden network devices being serviced. Consequently, the flow continues at block 506. If multiple existing proxy network devices each service the preferred number of other hidden network devices, it may be determined that the proxy network device cannot be selected based on the number of other hidden network devices being serviced. Also, if none of the existing proxy network devices services the preferred number of other hidden network devices, it may be determined that the proxy network device cannot be selected based on the number of other hidden network devices being serviced. If the proxy network device cannot be selected, the flow continues at block 508.

At block 506, the existing proxy network device that services the preferred number of other hidden network devices is selected as the proxy network device. In some embodiments, the proxy selection unit 110 can select the existing proxy network device that is currently servicing a fewest number of other hidden network devices as the proxy network device of the hidden network device. This can allow for load balancing across the existing proxy network devices. For example, the hidden network device may detect a first proxy network device that is currently servicing 100 other hidden network devices and a second proxy network device that is currently servicing 50 other hidden network devices. In this example, the proxy selection unit 110 may select the second proxy network device as the proxy network device. From block 506, the flow ends.

At block 508, it is determined whether the proxy network device can be selected based on a parameter that indicates a proxy configuration. The proxy configuration can indicate whether an existing proxy network device is statically configured or dynamically configured. The proxy selection unit 110 may determine whether the existing proxy network device is statically or dynamically configured based, at least in part, on an indicator included in the proxy beacon message received from the proxy network device. As discussed above, a network device 106 that is preconfigured as a proxy network device by a user (or network administrator) may be referred to as a statically configured proxy network device. The user may preconfigure the network device 106 as a proxy network device before a power ON/boot-up process or during an initial device configuration process. The user may preconfigure the proxy network device based on the user's knowledge of the network topology, a position of the network device 106 in the communication network, a wiring layout, simulation/test results, and/or other suitable factors. A network device 106 that is dynamically selected by a hidden network device (e.g., by executing proxy selection operations described herein) may be referred to as a dynamically configured proxy network device. In one example, the preferred proxy configuration may be a static configuration of the proxy network device if the user-selected proxy network devices have a higher priority. If only one existing proxy network device has the preferred proxy configuration, it may be determined that the proxy network device can be selected based on the proxy configuration and the flow continues at block 510. Otherwise, if multiple existing proxy network devices each have the preferred proxy configuration, it may be determined that the proxy network device cannot be selected based on the proxy configuration. Furthermore, if none of the existing proxy network devices have the preferred proxy configuration, it may be determined that the proxy network device cannot be selected based on the proxy configuration. If the proxy network device cannot be selected, the flow continues at block 512.

At block 510, the existing proxy network device that has the preferred proxy configuration is selected as the proxy network device. For example, if only one of the existing proxy network devices has the preferred proxy configuration, the proxy selection unit 110 may select this existing proxy network device as the proxy network device of the hidden network device. From block 510, the flow ends.

At block 512, it is determined whether the proxy network device can be selected based on a parameter that indicates a hop count. The proxy selection unit 110 may determine the hop count based, at least in part, on an indicator included in the proxy beacon message received from the proxy network device. The hop count of the proxy network device can indicate a number of communication hops (or communication links) between the proxy network device and the central coordinator 102. For example, if the proxy network device can directly communicate with (and is directly connected to) the central coordinator 102, the proxy network device may have a hop count of one. As another example, if the proxy network device communicates with the central coordinator 102 via two intermediate network devices, the proxy network device may have a hop count of three. In some embodiments, the preferred hop count may be the lowest hop count. A smaller number of hops can ensure higher reliability of communications between the hidden network device and the central coordinator. In another example, the proxy selection unit 110 may compare the hop count of an existing proxy network device against a threshold hop count. If the hop count is less than or equal to the threshold hop count, the existing proxy network device may be deemed to have a preferred hop count. If only one existing proxy network device has the preferred hop count, it may be determined that the proxy network device can be selected based on the hop count and the flow continues at block 514. Otherwise, if multiple existing proxy network devices each have the preferred hop count, it may be determined that the proxy network device cannot be selected based on the hop count. Furthermore, if none of the existing proxy network devices have the preferred hop count, it may be determined that the proxy network device cannot be selected based on the hop count. If the proxy network device cannot be selected, the flow continues at block 516.

At block 514, the existing proxy network device that has the preferred hop count is selected as the proxy network device. For example, if only one of the existing proxy network devices has the preferred hop count, the proxy selection unit 110 may select this existing proxy network device as the proxy network device of the hidden network device. From block 514, the flow ends.

At block 516, the existing proxy network device that has a preferred performance measurement is selected as the proxy network device. For example, if the proxy selection unit 110 is unable to select the proxy network device based on the number of serviced hidden network devices, the proxy configuration, and the hop count, the proxy selection unit 110 can identify the existing proxy network device that has a preferred performance measurement. In some embodiments, the proxy selection unit 110 may ignore those existing proxy network devices that have a performance measurement that is not in accordance with a performance measurement threshold. For example, while selecting the proxy network device, the proxy selection unit 110 may not take into consideration those existing proxy network devices that have a SNR that is less than an SNR threshold. As another example, while selecting the proxy network device, the proxy selection unit 110 may not take into consideration those existing proxy network devices that have an attenuation level that exceeds an attenuation threshold. In some embodiments, for each of the existing proxy network devices, the link establishment unit 112 can determine the performance measurement of a communication link between the hidden network device and the existing proxy network device. In this embodiment, the performance measurement may be determined at the hidden network device based on processing the received proxy beacon message received from the existing proxy network device.

In another embodiment, for each of the existing proxy network devices, the hidden network device can determine the performance measurement of a communication link between the existing proxy network device and the central coordinator (or an upper-level proxy network device). In this embodiment, the existing proxy network device may determine the performance measurement (based on communications between the central coordinator and the existing proxy network device) and may communicate the performance measurement to the hidden network device in the proxy beacon message. In yet another embodiment, for each of the existing proxy network devices, the hidden network device can determine the performance measurement associated with the existing proxy network device as a combination of: 1) a first performance measurement between the hidden network device and the existing proxy network device and 2) a second performance measurement between the central coordinator and the existing proxy network device. The performance measurement can include a signal-to-noise ratio (SNR), a signal level, an attenuation level, an error rate, and/or another indicator of signal quality. The existing proxy network device associated with the preferred performance measurement (e.g., highest SNR, lowest error rate, etc.) may be selected as the proxy network device. Selecting the proxy network device with the preferred performance measurement (e.g., the highest SNR) can ensure higher communication reliability between the hidden network device and the central coordinator 102. From block 516, the flow ends.

Although FIG. 5 describes operations for selecting a proxy network device from the existing proxy network devices, embodiments are not so limited. In other embodiments, the proxy selection unit 110 can execute the operations described above in FIG. 5 to select the proxy network device if multiple proxy-capable network devices (that are not currently operating as proxy network devices) transmitted corresponding discover beacon messages. In one example, if the hidden network device does not detect any existing proxy network devices, the proxy selection unit 110 may analyze discover beacon messages received from other network devices to determine whether any of the network devices have proxy capabilities. In some embodiments, the received discover beacon messages may include a parameter (referred to as “first communication parameter” in FIG. 2) that indicates whether the network device is a proxy-capable network device. After identifying the proxy-capable network devices, the proxy selection unit 110 can use one or more other parameters (referred to as “second communication parameter” in FIG. 2) to select the proxy network device from the proxy-capable network devices that are not currently operating as proxy network devices. For example, the proxy selection unit 100 may determine whether multiple proxy-capable network devices have the preferred hop count, as described with reference to block 512 of FIG. 5. If only one proxy-capable network device has the preferred hop count, that network device can be selected as the proxy network device, as described with reference to block 514 of FIG. 5. Otherwise, the proxy-capable network devices that have the preferred hop count can be further evaluated to select the proxy-capable network device associated with the preferred performance measurement as the proxy network device, as described with reference to block 516 of FIG. 5. Alternatively, if none of the proxy-capable network devices has the preferred hop count, the proxy-capable network device associated with the preferred performance measurement can be selected as the proxy network device.

In some embodiments, the proxy selection unit 110 may use other suitable combinations of some/all of the factors described above in FIG. 5 to select the proxy network device. Each factor used to select the proxy network device may be assigned a different priority/weight to enable the proxy selection unit 110 to select the appropriate proxy network device. For example, the existing proxy network devices may be evaluated in the following order: proxy configuration, hop count, number of hidden network devices being serviced, and performance measurement. In this example, the proxy configuration may be assigned the highest priority, followed by the number of hidden network devices being serviced, and finally the performance measurement. As another example, the proxy configuration may not be taken into consideration. More generally, the selection of the proxy network device may depend on user policy, powerline network conditions, the hidden network device, priority assigned to each parameter used for proxy selection, etc. In some embodiments, the priority/weight assigned to each of the parameters used to select the proxy network device may be preconfigured (e.g., by a user). As another example, the priority/weight assigned to each of the parameters used to select the proxy network device may be dynamically configured based, at least in part, on traffic in the communication network 100, performance of the network device 104 in the communication network 100, and so on.

FIG. 6 is a conceptual diagram illustrating example operations for constructing a routing table in a multi-level relay environment 600. FIG. 6 depicts a central coordinator (CCo) 602 and three network devices 604, 606, and 608. Using the operations described above in FIGS. 1-5, the network device 608 (“hidden network device” or “HSTA”) selects the network device 606 as its upper-level proxy network device (“PSTA2”). As depicted in FIG. 6, the network device 606 is also a hidden network device and is not directly connected to the central coordinator 604. The network device 606 also executes the operations described above in FIGS. 1-5 to select the network device 604 as its upper-level proxy network device (“PSTA1”). The network device 604 is directly connected to (and directly communicates with) the central coordinator 602. The central coordinator 602 and the network devices 604, 606, and 608 each include a routing table 610, 612, 614, and 616, respectively, for determining how to relay messages. The routing table can help the corresponding network device determine whether to relay a received message or drop/discard a received message. The routing table can also help the corresponding network device determine to which network device to relay the received message.

When the hidden network device 608 transmits an upstream message intended for the central coordinator 602, each network device 608, 606, and 604 relays the message to its respective upper-level proxy network device. For upstream communication, each network device 608, 606, and 604 typically includes one entry in the corresponding routing table 618, 614, and 612 that indicates the upper-level proxy network device. Referring to the example of FIG. 6, the hidden network device 608 selects the network device 606 as its upper-level proxy network device. Therefore, the routing table 616 of the hidden network device 608 includes an entry indicating that if the final destination address (FDA) is the central coordinator 602, then the message should be transmitted/relayed to the network device PSTA2 606. The network device 606 selects the network device 604 as its upper-level proxy network device. Therefore, the routing table 614 of the network device 606 includes an entry indicating that if the final destination address (FDA) is the central coordinator 602, then the message should be transmitted/relayed to the network device PSTA1 604. The network device 604 is directly connected to the central coordinator 602. Therefore, routing table 612 of the network device 604 includes an entry that identifies the central coordinator as the final destination address (FDA) but does not specify any relay/forwarding device. This can indicate that the network device 604 is directly connected to the central coordinator 602. Each network device 604, 606, and 608 can create an entry it the corresponding routing table 612, 614, and 616 for upstream communications after executing the proxy selection operations described in FIGS. 1-5.

The central coordinator 602 and the network devices 606 and 608 can use messages received from downstream network devices to populate entries in the routing table for downstream communication, as will be further described below. With reference to the example of FIG. 6, the hidden network device 608 is not connected to and does not operate as a proxy network device for another network device in the communication network. Therefore, the routing table 616 of the hidden network device 608 does not include any entry for downstream communication. The network device 606 is the upper-level proxy network device for the hidden network device 608 and is directly connected to the hidden network device 608. Therefore, the routing table 614 of the network device 606 includes an entry that identifies the hidden network device 608 as the final destination address but does not specify any relay/forwarding device. More generally, if the network device 606 is the upper-level proxy network device for N hidden network devices, the routing table 614 may include N separate entries—one for each of the hidden network devices serviced by the network device 606.

Referring to the example of FIG. 6, the hidden network device 608 determines to transmit an upstream message 618 to the central coordinator 602. The hidden network device 608 determines that the network device 606 is its upper-level proxy network device from the routing table 616 and transmits the message 618 to the network device 606. In some embodiments, the message 618 can include a destination address (DA) of a current hop communication link, a source address (SA) of the current hop communication link, an original source address (OSA) of the network device 608 that originally generated the message 618, and a final destination address (FDA) of the ultimate destination of the message 618. In this example, the message 618 can include an identifier of the hidden network device 608 as the original source address and the source address for the current communication link, an identifier of the central coordinator 602 as the final destination address, and an identifier of the network device 606 as the destination address for the current communication link. In some embodiments, if the hidden network device 608 is unaware of the identifier of the central coordinator 602, the message 618 can include a predetermined broadcast identifier. In some embodiments, the message 618 may also indicate whether the hidden network device is an associated or an unassociated network device in the communication network 600.

The network device 606 receives the message 618 from the hidden network device 608. The network device 606 determines that the network device 604 (PSTA1) is its upper-level proxy network device from the routing table 614. The network device 606 can determine whether it is directly connected to the central coordinator 602 by comparing the identifier of the central coordinator 602 against the identifier of the upper-level proxy network device 604. If there is a match, the proxy network device 604 can infer that it is directly connected to the central coordinator 102. As depicted in FIG. 6, the network device 606 is not directly connected to the central coordinator 602. The network device 606 updates one or more fields in the received message 618 to generate message 620. The message 620 can include an identifier of the hidden network device 608 as the original source address, an identifier of the central coordinator 602 as the final destination address, an identifier of network device 606 as the source address for the current communication link, and an identifier of the network device 604 as the destination address for the current communication link. Thus, the network device 606 may not change the original source address and final destination address entries in the received message 618. The network device 606 may only update the source and destination addresses for a current communication link based on information in the routing table 614 to form the message 620. In some embodiments, the message 620 may also indicate whether the hidden network device is an associated or an unassociated network device in the communication network. The network device 606 forwards the message 620 to its upper-level proxy network device 604.

The network device 604 receives the message 620 from the network device 606. The network device 604 determines that it is directly connected to the central coordinator 602 from the routing table 612. The network device 604 updates one or more fields in the received message 620 to generate message 622. The message 622 can include an identifier of the hidden network device 608 as the original source address, an identifier of the network device 604 as the source address for the current communication link, and an identifier of the central coordinator 602 as the final destination address and the destination address for the current communication link. Thus, the network device 604 may not change the original source address and final destination address entries in the received message 620. The network device 604 may only update the source and destination addresses for a current communication link based on information in the routing table 612 to form the message 622. In some embodiments, the message 618 may also indicate whether the hidden network device 608 is an associated or an unassociated network device in the communication network 600. The network device 604 forwards the message 622 to the central coordinator 602. In addition, the network device 604 can update the routing table 612 to include/update an entry for downstream communication with the hidden network device 608. Based on the received message 620, the network device 604 may determine that the network device 606 forwarded a message that was originally generated by the hidden network device 608. Accordingly, the routing table 612 may be updated to indicate that if the final destination address (FDA) is the hidden network device 608, then the message should be transmitted/relayed to the network device (PSTA2) 606.

In response to receiving the message 622, the central coordinator 602 can update the routing table 610 to include/update an entry for downstream communication with the hidden network device 608. Based on the received message 622, the central coordinator 602 can determine that the network device 604 forwarded a message that was originally generated by the hidden network device 608. Accordingly, the routing table 610 may be updated to indicate that if the final destination address (FDA) is the hidden network device 608, then the message should be transmitted/relayed to the network device (PSTA1) 604.

The central coordinator 602 can extract and process a payload portion of the received message 622. For example, if the central coordinator 602 received an association request from the hidden network device 608, the central coordinator 602 can process the association request and determine whether to associate with the hidden network device 608. When the central coordinator 602 transmits a downstream message to the hidden network device 608, each network device in the transmission path consults its corresponding routing table to determine how to route the message to the hidden network device 608. With reference to the example of FIG. 6, the central coordinator 602 generates message 624 for transmission to the hidden network device 608. The central coordinator 602 determines (from the routing table 610) that the message 624 destined for the hidden network device 608 should be forwarded to the network device 604. The message 624 can include an identifier of the hidden network device 608 as the final destination address, an identifier of the central coordinator 602 as the original source address and as the source address for the current communication link, and an identifier of the network device 604 as the destination address for the current communication link.

The network device 604 can receive the message 624 and determine that the message 624 is intended for the hidden network device 608. The network device 604 determines (from the routing table 612) that the message destined for the hidden network device 608 should be forwarded to the network device 606. The network device 604 can update one or more fields in the received message 624 to generate message 626. The message 626 can include an identifier of the hidden network device 608 as the final destination address, an identifier of the central coordinator 602 as the original source address, an identifier of the network device 604 as the source address for the current communication link, and an identifier of the network device 606 as the destination address for the current communication link. The network device 604 can transmit the message 626 to the network device 606.

The network device 606 can receive the message 626 and determine that the message 626 is intended for the hidden network device 608. The network device 606 determines (from the routing table 614) that the hidden network device 608 is directly connected to the network device 606. The network device 606 can update one or more fields in the received message 626 to generate message 628. The message 628 can include an identifier of the hidden network device 608 as the final destination address and the destination address for the current communication link, an identifier of the central coordinator 602 as the original source address, an identifier of the network device 606 as the source address for the current communication link. The network device 606 can transmit the message 628 to the hidden network device 608.

In some embodiments, each network device 604, 606, and 608 can be configured to periodically transmit their respective routing table 612, 614, and 616 to the central coordinator 602, without any trigger from the central coordinator 102. In another embodiment, the central coordinator 602 may explicitly transmit a request for the routing table associated with the network devices 604, 606, and 608. The network devices 604, 606, and 608 can transmit their corresponding routing tables in response to receiving the request from the central coordinator 602, at a predetermined time instant specified in the request, or a predetermined time interval after receiving the request from the central coordinator 602. The central coordinator 602 may use its routing table 610, the received routing tables 612, 614, and 616, discovered devices lists (described above in FIG. 1) received from each of the network devices and the discovered devices list of the central coordinator 602 to estimate the topology of the communication network and the interconnection between network devices in the communication network.

Although FIG. 6 describes a two-level forwarding process, embodiments are not so limited. In other embodiments, a network device may communicate with the central coordinator over any suitable number of forwarding levels. The upstream forwarding operations described in FIG. 6 can be successively executed at each forwarding level until the message originally transmitted by the hidden network device is received at the central coordinator 102. Likewise, downstream forwarding operations described in FIG. 6 can be successively executed at each forwarding level until the message originally transmitted by the hidden network device is received at the ultimate destination network device.

Although not depicted in FIG. 6, in some embodiments, the central coordinator 602 and the network devices 604, 606, and 608 can each implement an aging mechanism to update entries in the corresponding routing table 610, 612, 614, and 616. In some embodiments, each entry in the routing table may be associated with an aging timer. The aging timer can indicate an amount of time that has elapsed since a message was last received from a downstream network device. For example, the network device 606 may keep track of the amount of time elapsed since it last received a message from the hidden network device 608. The network device 606 can reset the aging timer that corresponds to the hidden network device 608 each time the network device 606 receives a message from the hidden network device 608. In another embodiment, if the proxy network device 606 receives a message from the hidden network device 608 within a predetermined time interval, the entry in the routing table 614 that corresponds to the hidden network device 608 may be updated and kept active. If the proxy network device 606 has not received any messages from the hidden network device 608 for the predetermined time interval, the proxy network device 606 can infer that the hidden network device 608 has left the communication network 600. The proxy network device 606 can delete the entry corresponding to the hidden network device 608 from the routing table 614. The proxy network device 606 may also transmit a message to the central coordinator 102 and/or the upper-level proxy network device 604 indicating that the hidden network device 608 is no longer active in the communication network 600. In response, the central coordinator 602 and/or the upper-level proxy network device 604 can delete any entries associated with the hidden network device 608 from their corresponding routing table 610 and/or 612. The central coordinator 602 may also broadcast a notification to indicate that the hidden network device 608 is no longer part of the communication network 600 and to cause all the other network devices to update their corresponding routing table. In some embodiments, the hidden network device 608 and the proxy network device 606 can exchange “keep alive” messages at periodic intervals. In doing so, the hidden network device 608 can indicate its presence in the communication network 600 even if the hidden network device 608 does not have any messages to transmit to the central coordinator 602 (via the proxy network device 606).

It should be understood that FIGS. 1-6 are examples meant to aid in understanding embodiments and should not be used to limit embodiments or limit scope of the claims. Embodiments may comprise additional components, different components, and/or may perform additional operations, fewer operations, operations in a different order, operations in parallel, and some operations differently. For example, the network devices 102, 104, 106, and 108 in the communication network 100 can be configured to transmit a small amount of management information (e.g., for generating and updating routing tables, for indicating presence in the communication network, and/or other management purposes). Accordingly, the network devices can be configured to use a robust transmission scheme for transmitting the management information. For example, the network devices 102, 104, 106, and 108 can be configured to transmit messages that have a size of less than 128 bytes for generating and updating routing tables, for indicating presence in the communication network, etc. In this example, the network devices 102, 104, 106, and 108 can be configured to transmit the messages using a mini-ROBO transmission mode. Using the robust transmission scheme can help enable successful data transmission in a high interference outdoor environment.

Although examples refer to the network devices 102, 104, 106, and 108 performing various operations based on a preconfigured time interval, a predetermined number of messages, and/or other predetermined factors, embodiments are not so limited. In other embodiments, the network devices 102, 104, 106, and 108 may perform various operations based on a configurable time interval, a configurable number of messages, and/or other configurable factors. The configurable factors may be statically configured (e.g., during an initialization/startup process) or dynamically configured.

In some embodiments, the number of network devices that can join the communication network 100 may be influenced by the length of the beacon interval and the number of network devices that can transmit discover beacon messages and proxy beacon messages (if needed) during the beacon interval. In other embodiments, the central coordinator 102 may extend the beacon interval (if needed) to accommodate a larger number of network devices in the communication network 100.

In some embodiments, the hidden network device may detect proxy beacon messages from multiple proxy network devices that belong to multiple communication networks (e.g., AVLNs) supported by a shared communication medium (e.g., a powerline medium). In this embodiment, after selecting the proxy network device (e.g., the network device 106) in accordance with operations described above, the hidden network device (e.g., the network device 104) may identify the communication network to which the selected proxy network device belongs. The hidden network device can exchange messages with the central coordinator 102 via the selected proxy network device to join the selected communication network. After joining the communication network, the hidden network device can synchronize with the selected proxy network device based, at least in part, on the proxy beacon message received from the selected proxy network device. For example, the hidden network device can update its local timers based, at least in part, on timing synchronization information in the received proxy beacon message. The hidden network device may not use received discover/proxy beacon messages from other network devices for synchronization. Instead, as discussed above, the proxy beacon messages and/or discover beacon messages from other network devices may be used to update a discovered devices list to determine the topology of the communication network.

In some embodiments, the proxy network device may disconnect from the communication network 100, may lose connectivity with the central coordinator 102, may lose connectivity with its upper-level proxy network device, and/or may lose connectivity with the hidden network device. The hidden network device may employ various techniques to remain connected to the communication network 100. In one embodiment, the hidden network device may attempt to reconnect with the proxy network device. In another embodiment, the hidden network device may attempt to select a new proxy network device that has the same relay level or a more preferred relay level as compared to the previous proxy network device. For example, the hidden network device may attempt to select a new proxy network device that has the same hop count or a lower hop count as compared to the previous proxy network device. In yet another embodiment, the hidden network device may select a new proxy network device from the previously detected network devices that correspond to previously received proxy/discover beacon messages (e.g., received at block 308 of FIG. 3). If the hidden network device cannot establish a communication link with any other the previously detected network devices, the hidden network device can execute operations described in blocks 306-312 to receive discover/proxy beacon messages and to select a new proxy network device.

In some embodiments (e.g., if the quality of the communication network 100 improves or if another network device becomes the central coordinator), the hidden network device may start to receive a central beacon message from the central coordinator 102, while the hidden network device is communicating via the proxy network device. If the hidden network device continuously detects the central coordinator 102 and receives the central beacon message for a predetermined time interval, the hidden network device may determine that it is no longer a hidden network device. Accordingly, the network device 104 may designate itself as a “normal” network device (NSTA) and may attempt to directly connect to the central coordinator 102. For example, if the hidden network device receives a central beacon message for a predetermined number of consecutive beacon intervals, the link establishment unit 112 may infer that the network device 104 is no longer a hidden network device and that the network device 104 should directly connect to the central coordinator 102. In some embodiments, the network device 104 may transmit a notification to the proxy network device (e.g., the network device 106) to disassociate from the proxy network device. The network device 106 may remove the network device 104 from its routing table to indicate that the network device 106 no longer services the network device 104. In another embodiment, after the network device 104 directly connects to the central coordinator 102, the central coordinator 102 may broadcast a notification indicating that the network device 104 is now directly connected to the central coordinator 102. The network devices 106 and 108 may update their respective routing tables to reflect that the network device 104 is now directly connected to the central coordinator 102.

To minimize frequent oscillations between being configured as a hidden network device and a normal network device, the network device 104 may switch its current configuration (e.g., between a hidden network device configuration and a normal network device configuration) after a predetermined time interval elapses. For example, the network device 104 may transition from the hidden network device configuration to the normal network device configuration, if the network device 104 receives a predetermined number of consecutive central beacon messages, receives a central beacon message for a predetermined number of consecutive beacon intervals, or continually receives a central beacon message for a configurable time interval. As another example, the network device 104 may transition from the normal network device configuration to the hidden network device configuration, if the network device 104 does not receive a predetermined number of consecutive central beacon messages, does not receive a central beacon message for a predetermined number of consecutive beacon intervals, or does not receive a central beacon message for a configurable time interval.

In some embodiments, instead of receiving the central beacon message, the hidden network device may receive a proxy beacon message transmitted by a proxy network device servicing the upper-level proxy network device of the hidden network device. Referring to the example of FIG. 6, the network device PSTA2 606 operates as a proxy network device for the hidden network device 608; while the network device PSTA1 604 operates as a proxy network device for the network device PSTA2 606. In some embodiments, the hidden network device 608 may start to receive the proxy/discover beacon messages transmitted from the network device 604. In some embodiments, the proxy beacon message received at the hidden network device 608 from the network device 606 may include an identifier (e.g., a MAC address, TEI, etc.) of the upper-level proxy network device 604 associated with the network device 606. Based on this information, the hidden network device 608 may determine that the network device 604 is the upper-level proxy network device for the network device 606. In this embodiment, the hidden network device 608 may select the network device 604 as its new proxy network device and may terminate the communication link with the old proxy network device 606. For example, the proxy selection unit 110 may select the network device 604 (associated with a lower hop count) as the new proxy network device of the hidden network device 608, if the hidden network device 608 receives a predetermined number of consecutive proxy/discover beacon messages from the network device 604. As another example, the proxy selection unit 110 may select the network device 604 as the new proxy network device of the hidden network device 608 if the hidden network device 608 receives a proxy/discover beacon message from the proxy network device 604 for a predetermined number of consecutive beacon intervals. As another example, the proxy selection unit 110 may select the network device 604 as the new proxy network device of the hidden network device 608 if the hidden network device 608 continually receives a proxy/discover beacon message from the network device 604 for configurable time interval.

With reference to FIG. 6, in some embodiments, the central coordinator 602 may broadcast a message in the communication network 600. Network devices (e.g., the network device 604) that are directly connected to the central coordinator 602 may receive the broadcast message and may re-broadcast the message in the communication network 600. A hidden network device may only receive and the process the broadcast message that is forwarded by its upper-level proxy network device. For example, the network device 606 may only process the broadcast message forwarded by its upper-level proxy network device 604. Likewise, the network device 608 may only process the broadcast message forwarded by its upper-level proxy network device 606. Thus, if the hidden network device 608 receives the broadcast message via the network devices 604 and 606, the hidden network device 608 may discard the broadcast message forwarded by the network device 604 and may process the broadcast message forwarded by the network device 606. Additionally, when a hidden network device receives a broadcast message from its upper-level proxy network device, the hidden network device may determine whether it is a proxy network device for another hidden network device. For example, after receiving the broadcast message from the network device 606, the network device 604 may determine that it is the proxy network device for the hidden network device 608. In this example, the network device 606 can forward the received broadcast message to the hidden network device. As another example, after receiving the broadcast message from the network device 604, the network device 608 may determine that it is not a proxy network device for another hidden network device. In this example, the network device 608 may not forward or re-broadcast the received message.

As discussed above, the proxy network device can relay information between the hidden network device and the central coordinator. In some embodiments, the information to be relayed may be too large to be stored in buffers of the hidden network device, the proxy network device, and/or the central coordinator. In one example of this embodiment, the hidden network device may fragment the information into multiple constituent messages and may transmit the constituent messages to the proxy network device for transmission to the central coordinator. In a multi-level forwarding environment (e.g., as described in FIG. 6), each upper-level proxy network device that receives the constituent messages may determine whether it is the final destination network device before attempting to defragment the constituent messages. For example, the hidden network device 608 may fragment information to be transmitted into multiple constituent messages and may transmit the constituent messages to the proxy network device 606. If the proxy network device 606 is not the final destination network device, the proxy network device 606 may identify the next network device 604 to which to forward the messages (from the routing table 614) and may forward the constituent messages to the next network device 604. The final destination network device can receive the constituent messages and can reconstruct the original defragmented message. More generally, the original source network device may fragment the information to be transmitted to generate multiple constituent messages. The proxy network devices at each level may not defragment the constituent messages and may simply forward the constituent messages to the upper-level proxy network device. The ultimate destination network device may use the constituent messages to reconstruct the original message.

As will be appreciated by one skilled in the art, aspects of the present inventive subject matter may be embodied as a system, method, or computer program product. Accordingly, aspects of the present inventive subject matter may take the form of an entirely hardware embodiment, a software embodiment (including firmware, resident software, micro-code, etc.) or an embodiment combining software and hardware aspects that may all generally be referred to herein as a “circuit,” “module” or “system.” Furthermore, aspects of the present inventive subject matter may take the form of a computer program product embodied in one or more computer readable medium(s) having computer readable program code embodied thereon.

Any combination of one or more non-transitory computer readable medium(s) may be utilized. Non-transitory computer-readable media comprise all computer-readable media, with the sole exception being a transitory, propagating signal. The non-transitory computer readable medium may be a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Computer program code embodied on a computer readable medium for carrying out operations for aspects of the present inventive subject matter may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present inventive subject matter are described with reference to flowchart illustrations and/or block diagrams of methods, apparatus (systems) and computer program products according to embodiments of the inventive subject matter. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

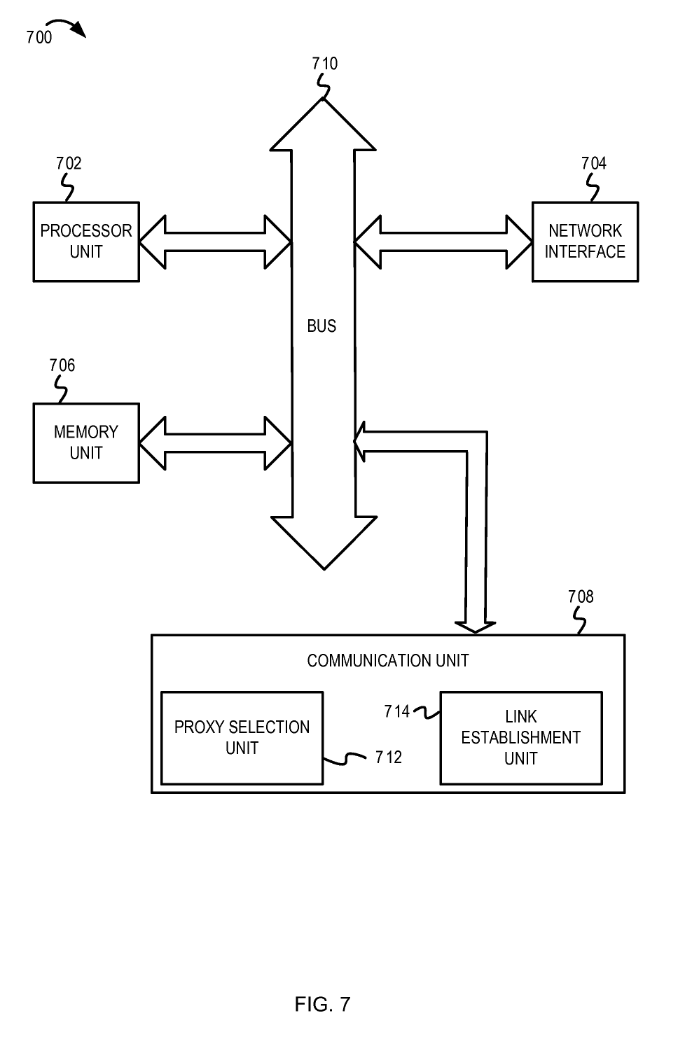

FIG. 7 is a block diagram of one embodiment of an electronic device 700 including a mechanism for selection of a proxy network device. In some implementations, the electronic device 700 may be a standalone or dedicated powerline communication (PLC) device connected in an outdoor powerline environment. In another embodiment, the electronic device 700 can be one of a desktop computer, laptop computer, a tablet computer, a smart appliance, a gaming console, a television, a set top box, a media player, or another electronic device comprising powerline communication capabilities. The electronic device 700 includes a processor unit 702 (possibly including multiple processors, multiple cores, multiple nodes, and/or implementing multi-threading, etc.). The electronic device 700 includes a memory unit 706. The memory unit 706 may be system memory (e.g., one or more of cache, SRAM, DRAM, zero capacitor RAM, Twin Transistor RAM, eDRAM, EDO RAM, DDR RAM, EEPROM, NRAM, RRAM, SONOS, PRAM, etc.) or any one or more of the above already described possible realizations of non-transitory machine-readable storage media. The electronic device 700 also includes a bus 710 (e.g., PCI, ISA, PCI-Express, HyperTransport®, InfiniBand®, NuBus, AHB, AXI, etc.). The electronic device 700 also includes a network interface 704 that include a wireless network interface (e.g., a WLAN interface, a Bluetooth® interface, a WiMAX interface, a ZigBee® interface, a Wireless USB interface, etc.) and/or a wired network interface (e.g., a PLC interface, an Ethernet interface, etc.). In some embodiments, the electronic device 700 may include a plurality of network interfaces—each of which couples the electronic device 700 to a different communication network. For example, the electronic device 700 can include a PLC interface, an Ethernet interface, and a WLAN interface that couple the electronic device 700 with a powerline communication network, an Ethernet, and a wireless local area network respectively. Furthermore, in some embodiments, the electronic device 700 can execute an IEEE Std. 1905.1 protocol for implementing hybrid communication functionality.

The electronic device 700 also includes a communication unit 708. The communication unit 708 includes a proxy selection unit 712 and a link establishment unit 714. The link establishment unit 714 can determine whether a central coordinator of a communication network can be detected at the electronic device 700. If the link establishment unit 714 is unable to detect the central coordinator within a predetermined time interval, the proxy selection unit 712 can determine that the electronic device 700 is a hidden network device. The proxy selection unit 712 can detect beacon messages from other network devices within the communication network and can use information in the detected beacon messages to select an appropriate detected network device as the proxy network device, as described above with reference to FIGS. 1-6. For example, the proxy selection unit 712 can select the proxy network device based, at least in part, whether a network device is currently configured as a proxy network device, how many other hidden network devices are being serviced by the network device, a hop count associated with the network device, a performance measurement associated with the network device, and/or other suitable factors.

Any one of these functionalities may be partially (or entirely) implemented in hardware and/or on the processor unit 702. For example, the functionality may be implemented with an application specific integrated circuit, in logic implemented in the processor unit 702, in a co-processor on a peripheral device or card, etc. In some embodiments, the communication unit 708 can each be implemented on a system-on-a-chip (SoC), an application specific integrated circuit (ASIC), or another suitable integrated circuit to enable communications of the electronic device 700. In some embodiments, the communication unit 708 may include additional processors and memory, and may be implemented in one or more integrated circuits on one or more circuit boards of the electronic device 700. Further, realizations may include fewer or additional components not illustrated in FIG. 7 (e.g., video cards, audio cards, additional network interfaces, peripheral devices, etc.). For example, in addition to the processor unit 702 coupled with the bus 710, the communication unit 708 may include at least one additional processor unit. As another example, although illustrated as being coupled to the bus 710, the memory unit 706 may be coupled to the processor unit 702.

While the embodiments are described with reference to various implementations and exploitations, it will be understood that these embodiments are illustrative and that the scope of the inventive subject matter is not limited to them. In general, techniques for proxy network device selection in a communication network as described herein may be implemented with facilities consistent with any hardware system or hardware systems. Many variations, modifications, additions, and improvements are possible.

Plural instances may be provided for components, operations, or structures described herein as a single instance. Finally, boundaries between various components, operations, and data stores are somewhat arbitrary, and particular operations are illustrated in the context of specific illustrative configurations. Other allocations of functionality are envisioned and may fall within the scope of the inventive subject matter. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the inventive subject matter.

What is claimed is:

1. A method comprising:
determining, at a first network device, that a central coordinator of a communication network cannot be detected by the first network device;
receiving a beacon message at the first network device from a second network device, the beacon message including a first communication parameter that indicates that the second network device has proxy capabilities and a second communication parameter;
determining that the second communication parameter of the second network device is a preferred communication parameter as compared to a corresponding second communication parameter of at least one additional network device detected by the first network device; and
selecting the second network device as a proxy network device for communication between the first network device and the central coordinator.

2. The method of claim 1, wherein said determining that the second communication parameter of the second network device is the preferred communication parameter is in response to:
determining, at the first network device, that the second network device is currently configured as a proxy network device for another network device of the communication network.

3. The method of claim 1, wherein said determining that the second communication parameter of the second network device is the preferred communication parameter and said selecting the second network device as the proxy network device comprises:
determining a number of hidden network devices serviced by each of the second network device and a third network device of the communication network; and
selecting the second network device as the proxy network device, in response to determining that the second network device services a preferred number of hidden network devices as compared to the third network device.

4. The method of claim 1, wherein said determining that the second communication parameter of the second network device is the preferred communication parameter and said selecting the second network device as the proxy network device comprises:
determining a proxy configuration associated with each of the second network device and a third network device of the communication network; and
selecting the second network device as the proxy network device, in response to determining that the second network device is associated with a preferred proxy configuration as compared to the third network device.

5. The method of claim 1, wherein said determining that the second communication parameter of the second network device is the preferred communication parameter and said selecting the second network device as the proxy network device comprises:
determining a number of communication hops between the second network device and the central coordinator and determining a number of communication hops between a third network device and the central coordinator; and
selecting the second network device as the proxy network device, in response to determining that the second network device is associated with a preferred number of communication hops as compared to the third network device.

6. The method of claim 1, wherein said determining that the second communication parameter of the second network device is the preferred communication parameter and said selecting the second network device as the proxy network device comprises:
determining a performance measurement associated with each of the second network device and a third network device of the communication network; and
selecting the second network device as the proxy network device, in response to determining that the second network device is associated with a preferred performance measurement as compared to the third network device.

7. The method of claim 1, further comprising comparing a third communication parameter associated with the second network device and a third communication parameter associated with the additional network device in response to:
determining that the second network device and the additional network device are each associated with a preferred second communication parameter; or
determining that neither the second network device nor the additional network device is associated with the preferred second communication parameter.

8. The method of claim 1, further comprising:
in response to determining that the central coordinator cannot be detected by the first network device during a first predetermined time interval,
initiating a second predetermined time interval at the first network device to detect at least the second network device of the communication network; and
receiving the beacon message at the first network device from the second network device during the second predetermined time interval,
wherein said determining that the second communication parameter of the second network device is the preferred communication parameter is in response to determining that the second predetermined time interval has elapsed.

9. The method of claim 1, further comprising:
receiving an indication from a third network device of the communication network that the first network device is a proxy network device for the third network device;
receiving a message at the first network device from the third network device for forwarding to the central coordinator of the communication network; and
transmitting the message from the first network device to the second network device for forwarding to the central coordinator.

10. The method of claim 1, further comprising:
updating a routing table of the first network device to indicate that a third network device is accessible via the first network device, in response to receiving an indication at the first network device from the third network device that the first network device is a proxy network device for the third network device; and
updating the routing table of the first network device to indicate that the third network device is not accessible via the first network device, in response to determining that the first network device has not consecutively received a predetermined number of messages from the third network device during a predetermined time interval.

11. The method of claim 1, wherein the second communication parameter of the second network device includes at least one of:
a number of communication hops from the second network device to the central coordinator,
an indication of whether the second network device is currently operating as a proxy network device,
an indication of whether second network device is a static configured proxy network device or a dynamic configured proxy network device, and
a number of network devices of the communication network currently being serviced by the second network device, if the second network device is currently operating as a proxy network device.

12. The method of claim 1, wherein:
the first network device, the central coordinator, the second network device, and the additional network device each include powerline communication (PLC) capabilities; and
the communication network is an outdoor powerline communication network.

13. The method of claim 1, wherein, in response to receiving a broadcast message at the first network device, the method further comprises:
determining whether the first network device is currently operating as a proxy network device;
forwarding the received broadcast message to a third network device of the communication network, in response to determining that the first network device is a proxy network device for the third network device; and
determining not to forward the received broadcast message, in response to determining that the first network device is not currently operating as a proxy network device.

14. The method of claim 1, wherein, in response to determining that the first network device is a proxy network device for a third network device of the communication network, the method further comprises:
determining whether the first network device is a final destination network device for a plurality of fragmented messages received from the third network device;
combining the plurality of fragmented messages and processing the combined plurality of fragmented messages, in response to determining that the first network device is the final destination network device; and
forwarding the plurality of fragmented messages to the second network device without combining the plurality of fragmented messages, in response to determining that the first network device is not the final destination network device.

15. The method of claim 1, further comprising:
receiving a predetermined number of consecutive beacon messages at the first network device from a third network device of the communication network;
determining that the third network device is an upper-level proxy network device for the second network device; and
establishing a communication link between the first network device and the third network device and terminating a communication link between the first network device and the second network device.

16. A first network device comprising:
a processor unit;
a link establishment unit coupled with the processor unit, the link establishment unit configured to:
determine that a central coordinator of a communication network cannot be detected by the first network device;
a proxy selection unit coupled with the processor unit, the proxy selection unit configured to:
receive a beacon message from a second network device, the beacon message including a first communication parameter that indicates that the second network device has proxy capabilities and a second communication parameter;
determine that the second communication parameter of the second network device is a preferred communication parameter as compared to a corresponding second communication parameter of at least one additional network device detected by the first network device; and
select the second network device as a proxy network device for communication between the first network device and the central coordinator.

17. The first network device of claim 16, wherein the proxy selection unit is further configured to compare a third communication parameter associated with the second network device and a third communication parameter associated with the additional network device in response to:
determining that the second network device and the additional network device are each associated with a preferred second communication parameter; or
determining that neither the second network device nor the additional network device is associated with the preferred second communication parameter.

18. The first network device of claim 16, wherein the proxy selection unit is further configured to:
receive a predetermined number of consecutive beacon messages at the first network device from a third network device of the communication network;
determine that the third network device is an upper-level proxy network device for the second network device; and
establish a communication link between the first network device and the third network device and terminating a communication link between the first network device and the second network device.

19. A non-transitory machine-readable storage medium having machine executable instructions stored therein, the machine executable instructions comprising instructions to:
determine, at a first network device, that a central coordinator of a communication network cannot be detected by the first network device;
receive a beacon message at the first network device from a second network device, the beacon message including a first communication parameter that indicates that the second network device has proxy capabilities and a second communication parameter;
determine that the second communication parameter of the second network device is a preferred communication parameter as compared to a corresponding second communication parameter of at least one additional network device detected by the first network device; and
select the second network device as a proxy network device for communication between the first network device and the central coordinator.

20. The non-transitory machine-readable storage medium of claim 19, wherein said instructions further comprise instructions to compare a third communication parameter associated with the second network device and a third communication parameter associated with the additional network device in response to:
determining that the second network device and the additional network device are each associated with a preferred second communication parameter; or
determining that neither the second network device nor the additional network device is associated with the preferred second communication parameter.
